(19) United States
(12) Patent Application Publication
(10) Pub. No.: US 2011/0136706 A1
(43) Pub. Date: Jun. 9, 2011

(54) ORGANOSULFONYL LATENT ACIDS FOR PETROLEUM WELL ACIDIZING

(75) Inventors: Glenn T. Carroll, Jeffersonville, PA (US); Gary E. Stringer, Birdsboro, PA (US); Gary S. Smith, Collegeville, PA (US)

(73) Assignee: Arkema Inc., Philadelphia, PA (US)

(21) Appl. No.: 13/029,358

(22) Filed: Feb. 17, 2011

Related U.S. Application Data
(62) Division of application No. 11/994,527, filed on Jan. 3, 2008.

(30) Foreign Application Priority Data
Jul. 12, 2006 (US) PCT/US06/26967

(51) Int. Cl. C09K 8/58

(52) U.S. Cl. 507/259

(57) ABSTRACT

Oil wells are treated with latent acids containing a sulfonyl moiety, wherein the latent acid is capable of providing an active acid after injection into an oil well. The latent acids are converted to active acids such as mineral acids or strong organic acids in the oil well, with resultant dissolution of acid-soluble minerals that impede oil or gas flow. Exemplary latent acids are according to any of formulas (I), (II), and (III)

R¹YSO₂X (I)

R¹YSO₃⁻⁺NHR²R³R⁴ (II)

(R¹YSO₃)ₚ(OR²)_{q}(NR³R⁴)ᵣM (III)

In formulas (I), (II), and (III), R¹ is selected from the group consisting of C₁-C₃₀ hydrocarbyl moieties, C₁-C₃₀ hydrocarbyl moieties appended to an oligomeric or polymeric chain, and C₁-C₃₀ hydrocarbyl moieties substituted with functional groups containing halogen, oxygen, sulfur, selenium, silicon, tin, lead, nitrogen, phosphorous, antimony, bismuth, aluminum, boron, or metals selected from Groups IA-IIA and IB-VIIIB of the periodic table; X is a halogen or ZCR²R³R⁴; Y and Z are independently O, S, Se, or NR⁵, and Y may also be a direct bond; R², R³, R⁴ and R⁵ are independently hydrogen or as defined for R¹ and wherein any two or more of R¹, R², R³, R⁴ and R⁵ may be interconnected to form one or more cyclic structures; M is a Group IVA metal, a Group IVB metal, a Group IB metal, or a Group IIB metal; and p+q+r=n wherein n is the valence of metal M.

The present application is a divisional application of U.S. patent application Ser. No. 11/994,527 filed Jan. 3, 2008.

### FIELD OF THE INVENTION

The invention relates to methods of treating oil or gas wells to enhance flow rates of the oil or gas.

### BACKGROUND OF THE INVENTION

Petroleum hydrocarbons are generically referred to as “oil” and include both hydrocarbon gases and liquids. The proportion of gas to liquids may vary and the commercial production may be predominately gases, or hydrocarbon liquids, or both. Within the earth's crust, reservoirs of such hydrocarbons typically occur within porous sedimentary strata containing silica-based minerals (e.g., sandstone, feldspars) and/or carbonate-based minerals (e.g., limestone, dolomite). Strata that are largely carbonate will also contain silica-based minerals and vice versa. Within these strata, the oil exists in microscopic pores interconnected by networks of microscopic flow channels. Various gases, water and brines also occupy the rock pores and are in contact with the oil. In petroleum production, the hydrocarbons are accessed through a wellbore drilled into the formation. The hydrocarbons flow through the rock formation to the wellbore, and ultimately to the surface, if the oil-bearing rock has pores of sufficient size and number to provide a sufficiently unimpeded flow path. Unfortunately, the flow in many formations is in fact somewhat impeded due to the presence of only relatively few, and/or relatively small, pores.

In addition to poor flow of oil due to a naturally impermeable formation, impeded flow can arise from “damage” to the formation. One source of such damage sometimes occurs as a consequence of the well drilling, completion, and production operations. This damage takes the form of mineral particles from the drilling and completion fluids that have coated the face of the wellbore or have invaded the near-wellbore strata, and mineral particles originally from the oil-bearing strata that were mobilized during the drilling, completion and production operations. The damage from these particles may occur at or near the wellbore, but may also occur anywhere along the flow path of the oil and water that migrate through the formation.

One approach to dealing with flow-impeding particulate minerals is called “matrix acidizing”, which involves injecting an acid or acid-based fluid, often along with other chemicals, through the wellbore to a targeted strata such that the acid can (a.) react with and dissolve particles and scale in the wellbore and near-wellbore strata or (b.) react with and dissolve small portions of the strata to create alternate flow paths around the damaged strata, thereby enhancing the permeability of the rock. Hydrochloric and/or hydrofluoric acid are commonly used for this purpose. A related process, called “acid fracturing”, involves injecting an acid and/or water, along with other chemicals, into the wellbore under sufficient pressure to fracture the targeted strata and create large flow channels through which the hydrocarbons can more readily migrate to the wellbore.

One common problem with using these strong mineral acids as acidizing agents is their poor radial penetration into the formation. This is a consequence of their immediate reactivity with the first damaging material or strata minerals with which they come into contact. This typically occurs immediately at or near the wellbore or along existing large fracture lines. This immediate reactivity may not be desirable in some cases, particularly those in which the first contact is likely to be in regions of the formation that have already been depleted of their contained oil, and not in the smaller channels where significant volumes of oil still reside.

### SUMMARY OF THE INVENTION

The invention provides a method of treating an oil well that includes injecting into the well a composition comprising a latent acid comprising a sulfonyl moiety. The latent acid is capable of providing an active acid after injection into an oil well.

### DETAILED DESCRIPTION OF THE INVENTION

### Latent Acids

This invention discloses a process for stimulating production of hydrocarbons from a petroleum well by treatment with latent acids. As used herein, the term “latent acid” means a compound that does not itself have substantial acidic character, but which is capable of being converted to a mineral acid or a strong organic acid (“active acid”) that is able to dissolve carbonates, silicates, sulfides, and/or other acid-soluble materials in an oil well. As used herein, the term “dissolve” includes reactive dissolution as well as simple dissolution. The latent acids of this invention include all compounds containing a sulfonyl moiety (—SO₂—) capable of providing an active acid after injection into an oil well. Three exemplary classes of such compound are shown below, but the invention is not limited to these.

One class of latent acids of this invention consists of compounds having structures according to formula (I).

R¹YSO₂X (I)

In formula (I), R¹ is selected from C₁-C₃₀ hydrocarbyl moieties optionally appended to an oligomeric or polymeric chain or substituted with functional groups containing halogen, oxygen, sulfur, selenium, silicon, tin, lead, nitrogen, phosphorous, antimony, bismuth, aluminum, boron, or metals selected from Groups IA-IIA and IB-VIIIB of the periodic table; X is a halogen (F, Cl, Br, I) or ZCR²R³R⁴; Y and Z are independently O, S, Se, or NR⁵, and Y may also be a direct bond; and R², R³, R⁴ and R⁵ are independently hydrogen or as defined for R¹. Hydrocarbyl moieties for any of R¹-R⁵ are typically any branched or linear alkyl group, aralkyl group, alkaryl group, or cyclic or alicyclic group.

Suitable nonlimiting examples of groups suitable for use as any of R¹-R⁵ are include straight-chain or branched-chain alkyl groups containing from one to six carbon atoms, such as methyl, ethyl, n-propyl, isopropyl, n-butyl, 2-butyl, tert-butyl, isobutyl, n-pentyl, 2-pentyl, tert-pentyl, isopentyl, neopentyl, 2-methylpentyl, n-hexyl, and isohexyl; straight-chain or branched-chain alkyl groups containing from seven to twenty carbon atoms, such as heptyl, 2-ethylhexyl, octyl, nonyl, 3,5-dimethyloctyl, 3,7-dimethyloctyl, decyl, undecyl, dodecyl, tridecyl, tetradecyl, 3-methyl-10-ethyldodecyl, pentadecyl, hexadecyl, heptadecyl, octadecyl, nonadecyl, eicosyl, and cocoalkyl; and hydrocarbyl groups containing from 1 to about 14 carbon atoms such as cyclohexylmethyl, benzyl, pinyl, pinylmethyl, phenethyl, p-methylbenzyl, phenyl, tolyl, xylyl, naphthyl, ethylphenyl, methylnaphthyl, dimethylnaphthyl, norbornyl, and norbornylmethyl. Further, any two or more of R¹, R², R³, R⁴ and R⁵ may optionally be interconnected to form one or more cyclic structures. Typically, if substituent groups are incorporated in any of R¹, R², R³, R⁴ and R⁵, the groups will contain halogen, oxygen, sulfur, nitrogen, silicon, or phosphorus. The preparation of latent acids of formula (I) may be effected by any method known in the chemical art. For example, suitable methods are reviewed in Chapter 10 of The Chemistry of Sulfonic Acids, Esters, and their Derivatives; Patai, S, Rappoport, Z., Eds.; pp. 351-399, John Wiley and Sons: New York, 1991.

A second class of latent acids consists of compounds according to formula (II)

R¹YSO₃⁻⁺NHR²R³R⁴ (II)

wherein Y and R¹-R⁴ are as defined above in relation to formula (I). Compounds according to formula (II) are ammonium salts of acids, and dissociation of these salts yields the free amine and the free acid, the latter of which is active for the purposes of this invention. Methods of preparing compounds according to formula (II) are well known to those of ordinary skill in the chemical art.

A third class of latent acids consists of compounds according to formula (III)

(R¹YSO₃)ₚ(OR²)_{q}(NR³R⁴)ᵣM (III)

wherein Y and R¹-R⁴ are as defined above in relation to formula (I); M is a Group IVA metal, a Group IVB metal, a Group IB metal, or a Group IIB metal; and p+q+r=n, where n is the valence of metal M. Any of R¹-R⁴ may optionally bear an additional oxygen or nitrogen substituent that bonds to another metal atom, so that dimeric, trimeric, oligomeric, and polymeric structures containing multiple metal atoms may also be made for use according to the invention. Nonlimiting examples include structures according to formula (IIIa),

{(R¹YSO₃)ₚ(OR²)_{q-1}(NR³R⁴)ᵣM-OCH₂—}₂ (IIIa)

which is a dimeric structure belonging to the general class (III) as shown above. Other examples include compounds according to formula (IIIb)

(R¹YSO₃)ₚ(OR²)_{q-2}(NR³R⁴)ᵣM(—OCH₂—CH₂O—) (IIIb)

where (—OCH₂—CH₂O—) represents an ethylene glycol moiety bonded at both ends to the same metal atom M.

Latent acids may react in the production zone of the well to form active acidic species, for example sulfonic acids, mineral acids, etc. These in turn react with minerals to form water-soluble salts, thus removing solid minerals to enhance to enhance the porosity of the rock formation, removing debris from the production zone or wellbore, or removing acid-labile materials purposely placed in the well to perform some particular function.

The latency characteristic of compounds according to formula (I) refers to their potential for delayed reactivity, thus allowing greater radial diffusion through the rock formation in the production zone of the well before formation of the acidic species and their subsequent reaction with carbonate, silicate, sulfide, or other minerals, which allows removal of the dissolved minerals from the formation and the wellbore. Exemplary water-soluble salts produced in this way include, as nonlimiting examples, calcium, magnesium, barium, and iron salts derived from methanesulfonic acid and hydrochloric acid, as well as fluorosilicates derived from hydrofluoric acid and siliceous minerals. The methanesulfonic (and in some cases, hydrochloric) acid generated by certain embodiments of this invention, particularly methanesulfonyl chloride and the various methanesulfonate esters, generally form highly soluble calcium and magnesium salts. Similarly, hexafluorosilicate salts of sodium, magnesium, and iron are also soluble. These may be formed, for example, when the latent acid is a sulfonyl fluoride that contacts silica deposits containing any of these metals. Latent acids according to formula (I) typically have relatively low solubility in water or brine media, and this is believed to contribute to their delayed reaction with water to form active acids.

Following are examples of reactions that may occur when the latent acids come into contact with carbonate-containing rock in the presence of water. It must be emphasized that these exemplary reactions, and those in the following sections, may or may not occur exactly as shown. The precise mechanisms are not critical to the practice of the invention, as long as dissolution of undesirable particles occurs in a manner sufficient to improve petroleum flow.

For removal of calcium carbonate with sulfonyl halides R¹SO₂X, where X is chloride, bromide or iodide, the following may occur:

$$\begin{matrix} {R}^{1} S {O}_{2} X + {H}_{2} O {\to }^{{H}_{2} O} {R}^{1} S {O}_{3} H + H X & ( Eqn . 1 a ) \\ {R}^{1} S {O}_{3} H + H X + 2 Ca C {O}_{3} + {H}_{2} O {\to }^{{H}_{2} O} {R}^{1} S {O}_{3}^{-} + {X}^{-} + 2 H C {O}_{3}^{-} + 2 {Ca}^{2 +} & ( Eqn . 1 b ) \\ {R}^{1} S {O}_{3} H + H X + Ca C {O}_{3} {\to }^{{H}_{2} O} {R}^{1} S {O}_{3}^{-} + {X}^{-} + {Ca}^{2 +} + C {O}_{2} + {H}_{2} O & ( Eqn . 1 c )\end{matrix}$$

Hydrolysis of sulfonyl halides is strongly temperature dependent, occurring at very slow rates at ambient temperatures, but more rapidly at elevated temperatures such as may typically be found in the production zone of an oil well. Also, sulfonyl halide latent acids useful in the practice of this invention are typically of relatively low solubility in water at neutral or acidic pH, and this also tends to slow the hydrolysis of the sulfonyl halide according to Eqn. 1a. Additionally, the pH of the production zone is typically high due to the presence of carbonates and/or other basic minerals, and this may accelerate the formation of active acids in those areas that contain such minerals. Thus, these dependencies of hydrolysis rate (i.e., Eqn. 1a) on the temperature and the pH of the medium may both contribute to the latency of acid activity for compounds of formula (I).

Once formed, the sulfonic (and hydrohalic, in some cases) acid will then diffuse through the largely aqueous medium until it contacts solid carbonate-containing minerals, whereupon the neutralization reactions (Eqns. 1b and 1c) may occur to form the water-soluble salt products. In the absence of other acidic or alkaline species, the degree of conversion of calcium carbonate to HCO₃⁻ or CO₂ species shown in Eqns. 1b and 1c depends on the pH of the aqueous medium, which in turn is governed by the relative rates of hydrolysis of the sulfonyl halide as compared to the dissolution and subsequent reaction of the carbonate species, as well as on the presence of other alkaline species other than carbonate that may be present.

Similar chemistry may operate for acid halides of the formula R¹YSO₂X. In this case, the R¹YSO₃⁻ species may undergo further hydrolysis and neutralizations to form R¹YH and hydrated forms of calcium sulfate.

$${R}^{1} Y S {O}_{3}^{-} + ( x + 1 ) {H}_{2} O + Ca C {O}_{3} {\to }^{{H}_{2} O} {R}^{1} Y H + Ca S {O}_{4} \cdot x {H}_{2} O + H C {O}_{3}^{-}$$

In cases where the latent acids are acid fluorides of the formula R¹SO₂F or R¹YSO₂F, one of the hydrolysis products is HF, which is strongly reactive with silica to form H₂SiF₆, which can subsequently react with carbonates or other basic minerals to form water-soluble hexafluorosilicate salts (not shown).

$$Si {O}_{2} + 6 H F {\to }^{{H}_{2} O} {H}_{2} Si {F}_{6} + 2 {H}_{2} O$$

In the case where the latent acids are esters of the formulas R¹SO₂ZCR²R³R⁴ and R¹YSO₂ZCR²R³R⁴, the initial hydrolysis reaction is also strongly temperature dependent. Moreover, the solubilities of these latent acids in aqueous media decrease markedly with increasing size of the R¹, R², R³ and R⁴ groups, thereby increasing their latency characteristics. Taking the case of the latent acids of the formula R¹SO₂OCR²R³R⁴ (i.e., Z═O) as an example, the initial hydrolysis reaction can be represented as follows, with resulting sulfonic acid R¹SO₃H further reacting with the calcium carbonate as previously discussed.

$${R}^{1} S {O}_{2} O C {R}^{2} {R}^{3} {R}^{4} + {H}_{2} O {\to }^{{H}_{2} O} {R}^{1} S {O}_{3} H + H O C {R}^{2} {R}^{3} {R}^{4}$$

$${R}^{1} S {O}_{3} H + Ca C {O}_{3} + {H}_{2} O {\to }^{{H}_{2} O} {R}^{1} S {O}_{3}^{-} + H C {O}_{3}^{-} + {Ca}^{2 +}$$

$$2 {R}^{1} S {O}_{3} H + Ca C {O}_{3} {\to }^{{H}_{2} O} 2 {R}^{1} S {O}_{3}^{-} + {Ca}^{2} + C {O}_{2} + {H}_{2} O$$

In the case where the latent acids are esters of the formulas R¹SO₂ZCR²R³R⁴ and R¹YSO₂ZCR²R³R⁴, incorporation of nucleophilic agents into the formulation may in some embodiments be used to increase the rate of conversion of the latent acid to an active acid. In the case of latent acids of the formula R¹SO₂OCR²R³R⁴ (i.e., Z═O) as an example, the initial reaction with the nucleophile (Nu-H) can be represented as follows, with the resulting sulfonic acid R¹SO₃H further reacting with the calcium carbonate as previously discussed.

$${R}^{1} S {O}_{2} O C {R}^{2} {R}^{3} {R}^{4} + Nu \text{-} H {\to }^{{H}_{2} O} {R}^{1} S {O}_{3} H + Nu \text{-} C {R}^{2} {R}^{3} {R}^{4}$$

$${R}^{1} S {O}_{3} H + Ca C {O}_{3} + {H}_{2} O {\to }^{{H}_{2} O} {R}^{1} S {O}_{3}^{-} + H C {O}_{3}^{-} + {Ca}^{2 +}$$

$$2 {R}^{1} S {O}_{3} H + Ca C {O}_{3} {\to }^{{H}_{2} O} 2 {R}^{1} S {O}_{3}^{-} + {Ca}^{2 +} + C {O}_{2} + {H}_{2} O$$

### Other Ingredients

In order to modify the reactivity and improve the handling characteristics of the latent acids, it may be desirable to combine them in a formulation with other materials such as catalysts, solvents, water, aqueous acids or salts, emulsifying agents, corrosion inhibitors, viscosity modifiers, etc. Such additives may, for example, alter reactivity, provide an additional benefit such as corrosion protection, improved handling characteristics, decreased vapor pressure of undesirable components, or produce or modify the additive on the surface prior to injection into the well, in the well, or in the rock formation. Depending on the solubility characteristics of the latent acid, any number of organic solvents may also be added. Examples of suitable solvents for some or all of the above latent acids include diesel fuel, toluene, xylenes, halogenated solvents, alcohols, ketones, and esters. The latent acids may also be prepared in the form of an emulsion or suspension incorporating water, aqueous acids or salts, emulsifying agents, and optional solvents. Hydrochloric acid, hydrofluoric acid, sulfamic acid, acetic acid, and formic acid are examples of suitable aqueous acids.

In those cases where the latent acid presents worker-exposure or flammability hazards, it may also be combined with an immiscible liquid with a density substantially lower than that of the latent acid, such that the immiscible liquid serves as a barrier to reduce the vapor pressure of the latent acid. Such barrier materials may include low-flammability hydrocarbons (e.g., mineral oils), and silicone fluids. Alternatively, the latent acids may be combined with solid organic or inorganic adsorbants, so as to allow the controlled release of the latent acids when these combined materials are suspended in water or other media for delivery to the targeted strata via the wellbore. Examples of suitable adsorbants include clays, aluminas, silicas, polyacrylic acids/amides/esters, polymethacrylic acids/amides/esters, polyamides, polyesters, polyethers, polyvinyl alcohol, etc., possessing suitable adsorptive and release properties for the particular latent acid being employed. The latent acid may be formulated within an encapsulating material such as wax.

Catalysts may also be added to modify the reactivity of the latent acid. Nonlimiting examples may include compounds with amine, amine salt, amide, thiol, quaternary ammonium, quaternary phosphonium, sulfonium chemical functionality. Examples of the quaternary ammonium and phosphonium catalysts include tetrabutylammonium, methyl tributylammonium (e.g., Cog nis ALIQUAT-175), methyl tricaprylylammonium (e.g., Cognis ALIQUAT-336), N-methyl-N-butyl imidazolium, hexaethylguanidinium, or tetrabutylphosphonium (e.g., Cytec CYPOS-442) salts. Examples of amine catalysts include tertiary or aromatic amines such as triethylamine, ethyl diisopropyl amine, pyridine, quinoline, and lutidine, or their salt forms. Examples of the amides include formamide, acetamide, pyrrolidinone, polyvinylacetamide, urea, and N-alkylated analogs thereof. Examples of thiol catalysts include alkyl or aromatic thiols, thiophenol, thioglycolic acid, cysteine, mercaptoethanesulfonic acid or its salts, and mercaptopropanesulfonic acid or its salts. Other catalysts include nonionic or anionic surfactants.

Nucleophilic agents may optionally be incorporated into these formulations in super- or sub-stoichiometric amounts to modify the reactivity of the latent acids, particularly when the latent acids is a sulfonate ester of the formula R¹SO₂OCR²R³R⁴ or R¹YSO₂OCR²R³R⁴ as defined above. In these cases, the nucleophile may react with the —CR²R³R⁴ group to liberate the R¹SO₃⁻ or R¹YSO₃⁻ groups in salt or acid form for reaction with carbonate, silicate, sulfide, or other minerals. Representative examples of these nucleophilic agents include, but are not limited to, amines, thiols, alcohols, and combination thereof, such as triethylamine, triethanolamine, diethylamine, diethanolamine, dibutylamine, diamylamine, pyridine, quinolines, lutidine, C₁-C₃₀ alkanethiols, dithiols or polythiols, n-dodecanethiol, t-dodecanethiol, alkanois, diol, polyols, methanol, isopropanol, ethylene glycol, diethyleneglycol, triethylene glycol, ethylene glycol monoethers, 2-ethylhexanol, octanol, fatty alcohols, phenol, and cresols. Typically, thiols or amines will be used. An extension of the above involves the use of sulfite as the nucleophile, wherein the resulting products is two sulfonic salts. An example is the reaction of sodium sulfite with methyl methanesulfonate as follows.

CH₃SO₃CH₃+NaHSO₃→CH₃SO₃Na+CH₃SO₃H

Another embodiment of the invention uses a formulation wherein a first latent acid reacts with another ingredient to form a second latent acid in the well or the production zone. One exemplary embodiment uses a formulation comprising a sulfonyl chloride (the first latent acid), an alcohol and optionally a catalyst and/or solvent. The alcohol reacts with the sulfonyl chloride to produce a sulfonate ester (the second latent acid) and hydrochloric acid (an active acid).

Another embodiment uses a formulation that comprises a latent acid that can be oxidized in the wellbore to a sulfonic acid. For example, a thiolsulfonate may be formulated with an oxidizing agent so that upon contact with high temperature or a catalyst in the well, a sulfonic acid is produced. Nonlimiting examples of suitable oxidizers include hydrogen peroxide, inorganic peroxides, organic peroxides or hydroperoxides, nitric acid, halogens, and hypohalite salts.

It should be noted that certain materials, when used in combination with the latent acids of formula (I), may have a substantial effect on certain important performance properties of the latent acid. In particular, materials that might tend to form insoluble products by reaction with the latent acid (or active acids derived from it) may or may not be undesirable in a given situation, and therefore some embodiments of the invention preclude the addition of such compounds in amounts that produce significant quantities of insoluble products. Nonlimiting examples of substances that may produce significant quantities of insoluble products include soluble aluminum compounds, including but not limited to alkali metal aluminates, and soluble chromium compounds, including but not limited to CrCl₃. These compounds tend to form insoluble hydroxides, oxides, and/or other precipitates when contacted with latent acids and/or the active acids derived from them.

### Application of Latent Acids

The process of this invention involves injection of the latent acids, optionally within a formulation also comprising catalysts, solvents, water, aqueous acids or salts, emulsifying agents, encapsulating agents, vapor-pressure reducing materials, corrosion inhibitors, viscosity modifiers, and/or other ingredients, into the wellbore and production zone of the well. Any or all of the various components of the formulation may be co-injected with the latent acid, or they may be injected before or after the injection of the latent acid.

In some embodiments, the composition is injected into strata in the well having a temperature from 20 to 250° C., typically from 50 to 150° C. In some embodiments, the strata contain predominately silica-containing rock, and in such cases it may be use for the latent acid to comprise R¹SO₂F or R¹YSO₂F. Alternatively, the latent acid may comprise R¹SO₂C¹ or R¹YSO₂Cl, and it may be accompanied by sodium fluoride, potassium fluoride, or barium fluoride so that HE is ultimately formed in the strata. HCl and/or HF themselves may also be added to these or any other formulation containing a latent acid.

### EXAMPLES

### Example 1

### Methanesulfonyl Chloride as Latent Acid for Reaction with Calcium Carbonate in Water and in Brine in the Absence of Organic Solvents

Four identical mixtures of methanesulfonyl chloride (MSC, 0.12 g), calcium carbonate powder (0.50 g, 6 μm mean particle size), and water (2.00 g) were prepared in 10-mL glass tubes. Similarly, four identical mixtures of methanesulfonyl chloride (0.12 g), calcium carbonate powder (0.50 g, 6 μm mean particle size), and brine (0.66 g NaCl and 2.00 g water) were also prepared in 10-mL tubes. The individual sealed glass tubes containing these combinations of reactants were heated at 80° C. with magnetic stirring in a microwave reactor for the times tabulated below.

For each tube, the following workup was employed: The tube was vented of formed CO₂ gas and the contents transferred to a syringe fitted with a filter. The syringe piston was then reattached and the liquid contents were forced through the filter and collected. The mixed aqueous and organic filtrates were allowed to separate and the organic phase removed by pipette. The solids in the filter were then washed with fresh 12-dichloroethane (2.00 g) to remove any absorbed organics and allowed to combine with the original aqueous phase. The combined aqueous phase and organic washings were then shaken to extract any residual sulfonyl chloride in the aqueous phase, and the organic washings combined with the previously organic phase.

The combined organic phases for each tube were analyzed by gas chromatography to determine the amount of unreacted sulfonyl chloride. The initial amount of sulfonyl chloride in each reaction tube (i.e., time zero=100% residual sulfonyl chloride) was determined by the gas chromatographic analysis of a mixture of the sulfonyl chloride (0.12 g) and the dichloroethane (4.0 g).

| | | | % Residual Sulfonyl |
|---|---|---|---|
| No. | Time (min.) | Medium | Chloride |
| 1A. | 0 | water | 100% |
| | 5 | water | 1.8% |
| | 30 | water | 0.94% |
| | 60 | water | 0.8% |
| | 120 | water | 0.8% |
| 1B | 0 | brine | 100% |
| | 5 | brine | 56.4% |
| | 30 | brine | 51.7% |
| | 60 | brine | 40.7% |
| | 120 | brine | 33.1% |

Evaluation of these data reveals that the hydrolysis reaction in water was largely complete within the first five minutes, while the hydrolysis rate in brine was substantially suppressed, indicating greater latency in media with high ionic strength,

### Comparative Example 2

### Reaction of Calcium Carbonate with Methanesulfonic Acid and with Hydrogen Chloride

Methanesulfonic Acid (70%, 0.288 g, 2.10 m mol) was combined with brine (0.66 g NaCl in 2.00 g water). Calcium carbonate (0.50 g, 5.0 mmol) was then added and the mixture heated at 80° C. for 30 minutes. The undissolved solids were then removed by filtration. The experiment was repeated using an equimolar amount of hydrochloric acid (37%, 0.206 g) in place of the methanesulfonic acid. Examination of both aqueous filtrates by inductively-coupled plasma spectroscopy revealed each to contain ca. 16000 ppm (1.6%) Ca²⁺ content.

### Example 3

### Methanesulfonyl Chloride in Combination with Solvents as Latent Acids for Reaction with Calcium Carbonate in the Presence of Organic Solvents

Using the same procedures as described in Example 1, seven mixtures containing methanesulfonyl chloride (MSC, 0.12 g, 1.05 mmol), 1,2-dichloroethane or mixed-xylenes solvent (DCE or XYL, 2.00 g), calcium carbonate powder (0.50 g, bpm mean particle size), and brine (0.66 g NaCl and 2.00 g water) were reacted at 80° C. or 120° C., separated and analyzed by gas chromatography. The results are tabulated below. In addition, the aqueous phase from each reaction was analyzed by inductively-coupled plasma spectroscopy to determined the Ca²⁺ content.

| | | | Reaction and | % Residual | ppm Ca²⁺ |
|---|---|---|---|---|---|
| | Time | Temp. | Extraction | Sulfonyl Chloride | in aq. |
| No. | (minutes) | (° C.) | Solvent | in Reaction | phase |
| 3A | 5 | 80 | XYL | 92.2% | 1000 |
| | 30 | 80 | ″ | 70.0% | 4000 |
| 3B | 15 | 80 | DCE | 97.3% | 617 |
| | 30 | 80 | ″ | 72.0% | 1300 |
| | 45 | 80 | ″ | 66.7% | 2800 |
| 3C | 3 | 120 | DCE | 86.6% | 1200 |
| | 6 | 120 | ″ | 59.4% | 7300 |
| | 10 | 120 | ″ | 41.7% | 9300 |

Evaluation of these data confirm an increase in the amount of dissolved calcium salts in the reaction mixtures as the hydrolysis of the sulfonyl chloride proceeded in the presence of either organic solvent. Moreover, comparison of the levels of residual MSC in the reaction mixtures 3A and 3S with those reported in 1A revealed slower hydrolysis rates in the presence of the solvents as compared with the hydrolysis rates in the absence of the solvents. The data also illustrate the effect of increasing reaction temperature.

### Example 4

### Butyl Methanesulfonates as Latent Acids for Reaction with Calcium Carbonate

Using the same procedures as described in Example 1 but replacing the sulfonyl chloride with either n-butyl methanesulfonate (nBMS, 0.15 g) or sec-butyl methanesulfonate (sBMS, 0.15 g) and only using brine as the aqueous phase, nine reaction mixtures were prepared, reacted, separated and analyzed. The results are tabulated below.

| | | | | % Residual | ppm Ca²⁺ |
|---|---|---|---|---|---|
| | Time | Temp. | Sulfonate | Sulfonate Ester in | in aq. |
| No. | (minutes) | (° C.) | Ester | Reaction | phase |
| 4A | 30 | 80 | nBMS | 92.4% | 107 |
| | 60 | 80 | ″ | 95.1% | 187 |
| 4B | 5 | 120 | nBMS | 97.0% | 194 |
| | 10 | 120 | ″ | 98.2% | 401 |
| | 30 | 120 | ″ | 90% | 491 |
| 4C | 120 | 80 | sBMS | 54.3% | 323 |
| 4D | 5 | 120 | sBMS | 94.0% | 953 |
| | 10 | 120 | ″ | 71.6% | 4200 |
| | 30 | 120 | ″ | 18.7% | 8700 |

Evaluation of these data reveal a much slower reactivity of these sulfonate esters in brine media as compared to the sulfonyl chloride (MSC) in Examples 1 and 3. The greater reactivity and thus poorer latency of the secondary-alkyl methanesulfonate (sBMS), as compared to the primary-alkyl methanesulfonate (nBMS), is clearly illustrated in the high temperature runs.

### Example 5

### Octyl Methanesulfonates as Latent Acids for Reaction with Calcium Carbonate in Brine

Using the same procedures as described in Example 1 but replacing the sulfonyl chloride with n-octyl methanesulfonate (nOMS, 0.44 g) or 2-ethylhexyl methanesulfonate (EHMS, 0.45 g), using brine as the aqueous phase, and reducing the CaCO₃ charge (0.20 g), four reaction mixtures were prepared, reacted, separated and analyzed by gas chromatography to determine residual sulfonate ester. The results are tabulated below.

| | | | | | | % Residual |
|---|---|---|---|---|---|---|
| | Time | Temp. | Sulfonate | | Extraction | Latent Acid |
| No. | (minutes) | (° C.) | Ester | Reaction Solvent | Solvent | in reaction |
| 5A | 30 | 80 | nOMS | DCE (2.00 g) | DCE (1 × 2 g) | No reaction |
| 5B | 30 | 120 | nOMS | DCE (2.00 g) | DCE (1 × 2 g) | No reaction |
| 5C | 0 | — | nOMS | none | DCE (2 × 2 g) | 100% |
| | 30 | 120 | nOMS | none | DCE (2 × 2 g) | 96.0% |
| 5D | 0 | — | nOMS | none | DCE (2 × 2 g) | 100% |
| | 3600 | 60 | nOMS | none | DCE (2 × 2 g) | 99.2% |
| 5E | 120 | 80 | EHMS | none | DCE (2 × 2 g) | No reaction |

Evaluation of these data reveal even slower reactivity of the nOMS as compared to the short-chain sulfonate esters described in Example 4.

### Example 6

### Octyl Methanesulfonates in Combination with Quaternary-Ammonium Phase-Transfer Catalysts as Latent Acids for Reaction with Calcium Carbonate

Reaction mixtures containing n-octyl methanesulfonate (nOMS, 0.44 g) or 2-ethylhexyl methanesulfonate (EHMS), brine (0.66 g NaCl in 2.00 g water), calcium carbonate (0.20 g) and a catalytic amount of either methyl tributylammonium chloride (MTBAC, Cognis ALIQUAT-175) or methyl tricaprylammonium chloride (MTCAC, Cognis ALIQUAT-336) were prepared, reacted as discussed Example 3. In these experiments, the amount of catalyst was 0.01-0.10 mol/mol relative to the sulfonate ester, as indicated below. After venting off the resulting gas (CO₂), the workup was modified such that 2.00 g of fresh 1,2-dichloroethane extraction solvent was added to the reaction mixture in each tube. The contents of the tube was transferred to a syringe fitted with a filter. The separation and analysis procedures was then continued as in Example 1.

| | | | | | | % Residual |
|---|---|---|---|---|---|---|
| | | | | Catalyst | | Sulfonate |
| | Time | Temp. | Sulfonate | (mmol/mol | Extraction | Ester in |
| No. | (minutes) | (° C.) | Ester | sulfonate ester) | Solvent | reaction |
| 6A | 60 | 80 | nOMS | MTCAC (0.01) | DCE (2 × 2 g) | 80.6% |
| 6B | 60 | 80 | ″ | MTCAC (0.10) | DCE (2 × 2 g) | 23.1% |
| 6C | 60 | 120 | ″ | MTCAC (0.10) | DCE (2 × 2 g) | 0.2% |
| 6D | 30 | 120 | ″ | MTCAC (one drop) | DCE (2 × 2 g) | 8.6% |
| 6E | 60 | 80 | ″ | MTBAC (0.01) | DCE (2 × 2 g) | 73.4% |
| 6F | 60 | 80 | ″ | MTBAC (0.10) | DCE (2 × 2 g) | 48.1% |
| 6G | 60 | 120 | ″ | MTBAC (0.10) | DCE (2 × 2 g) | 15.5% |
| 6H | 30 | 80 | EHMS | MTBAC (0.06) | DCE (2 × 2 g) | 53.3% |
| 6I | 120 | 80 | ″ | MTBAC (0.06) | DCE (2 × 2 g) | 46.3% |
| 6J | 180 | 80 | ″ | MTBAC (0.06) | DCE (2 × 2 g) | 42.1% |
| 6K | 5 | 120 | ″ | MTBAC (0.06) | DCE (2 × 2 g) | 44.6% |
| 6L | 30 | 120 | ″ | MTBAC (0.06) | DCE (2 × 2 g) | 15.7% |

Comparison of these data with those of Example 5 reveal a significant catalytic effect of these quaternary alkyl-ammonium chlorides for the hydrolysis of the sulfonate esters at either 80° C. or 120° C. Comparing the efficacies of the two catalysts, the MTBAC offered slower reactivity and thus greater latency. For both catalysts, it was possible to modify the reaction rate by varying the amount of catalyst.

### Example 7

### Octyl Methanesulfonate in Combination with Other Surfactants/Catalysts for Reaction for Reaction with Calcium Carbonate as Latent Acid

The relative efficacy of nonionic surfactants and anionic surfactants as catalysts to modify the hydrolysis rates of octyl methanesulfonate was compared with that for a quaternary alkylammonium salt (methyl tributylammonium chloride, MTBAC). The tested materials included PLURONIC non-ionic surfactants (products of BASF) and ARISTONATE anionic surfactants (products of Pilot Chemical Co.)

Using the procedures described in Example 6, n-octyl methanesulfonate (nOMS, 0.44 g) was contacted with calcium carbonate (0.20 g) in brine (0.66 g NaCl and 2.00 g water) at 80° C. for 120 minutes in the presence of the prospective catalysts (0.44 g). The results are tabulated below.

| | | Relative Amount % | Relative amounts of |
|---|---|---|---|
| Expt. | Catalyst | Residual nOMs | octanol formed. |
| 7A | MTBAC | 1 | 1 |
| 7B | Pilot ARISTONATE L | 4.57 | 0.116 |
| 7C | Pilot ARISTONATE | 4.86 | 0.065 |
| | H | | |
| 7D | BASF PLURONIC | 5.11 | 0.067 |
| | L-61 | | |
| 7E | BASF PLURONIC P- | 5.17 | 0.074 |
| | 105 | | |
| 7F | BASF PLURONIC L- | 5.73 | 0.066 |
| | 101 | | |

On an equal-weight basis and based on the amount of octanol formed, the quaternary alkylammonium catalyst provided 8.6-15.2 times the hydrolysis rate as compared to the non-ionic and anionic surfactants.

### Comparative Example 8

### Reaction of Aryl Esters of Methanesulfonic Acid or Octanesulfonic Acid with Aqueous Calcium Carbonate or Sodium Hydroxide

Reaction of phenyl methanesulfonate, water, calcium carbonate and methyl tributylammonium chloride phase transfer catalyst under the conditions described in Example 6 revealed no reaction of this aryl methanesulfonate at reaction temperatures of 80 or 120° C. Similarly, no reaction was observed for phenyl octanesulfonate with CaCO₃ in saturated brine, or with phenyl methanesulfonate with aqueous sodium hydroxide in the absence of brine. Thus, aromatic sulfonate esters are not preferred latent acids for the purposes of this invention under these particular conditions. However, they may prove suitable when combined with other catalysts or other additives, and/or at higher temperatures.

Although the invention is illustrated and described herein with reference to specific embodiments, it is not intended that the subjoined claims be limited to the details shown. Rather, it is expected that various modifications may be made in these details by those skilled in the art, which modifications may still be within the spirit and scope of the claimed subject matter and it is intended that these claims be construed accordingly.

What is claimed:

1. A method of treating an oil well, comprising injecting into the well a composition comprising a latent acid comprising a sulfonyl ester, wherein the latent acid reacts to form an active acid after injection into an oil well.

2. The method of claim 1, wherein the composition further comprises a nucleophile.

3. The method of claim 1, wherein the step of injecting the composition comprises injecting it into strata in the well having a temperature from 20 to 250° C.

4. The method of claim 1, wherein the step of injecting the composition comprises injecting it into strata in the well having a temperature from 50 to 150° C.

6. The method of claim 1, wherein the latent acid is according to the of formula
R¹YSO₂ZCR²R³R⁴
wherein R¹ is selected from the group consisting of C₁-C₃₀ hydrocarbyl moieties, C₁-C₃₀ hydrocarbyl moieties appended to an oligomeric or polymeric chain, and C₁-C₃₀ hydrocarbyl moieties substituted with functional groups containing halogen, oxygen, sulfur, selenium, silicon, tin, lead, nitrogen, phosphorous, antimony, bismuth, aluminum, boron, or metals selected from Groups IA-IIA and IB-VIIIB of the periodic table; Y and Z are independently O, S, Se, or NR⁵, and Y may also be a direct bond; R², R³ and R⁴ are independently hydrogen or as defined for R¹ and wherein any two or more of R¹, R², R³ and R⁴ may be interconnected to form one or more cyclic structures.

5. The method of claim 1, wherein the latent acid is according to the of formula
(R¹YSO₃)ₚ(OR²)_{q}(NR³R⁴)ᵣM
wherein R¹ is selected from the group consisting of C₁-C₃₀ hydrocarbyl moieties, C₁-C₃₀ hydrocarbyl moieties appended to an oligomeric or polymeric chain, and C₁-C₃₀ hydrocarbyl moieties substituted with functional groups containing halogen, oxygen, sulfur, selenium, silicon, tin, lead, nitrogen, phosphorous, antimony, bismuth, aluminum, boron, or metals selected from Groups IA-IIA and IB-VIIIB of the periodic table; Y and Z are independently O, S, Se, or NR⁵, and Y may also be a direct bond; R², R³ and R⁴ are independently hydrogen or as defined for R¹ and wherein any two or more of R¹, R², R³ and R⁴ may be interconnected to form one or more cyclic structures; M is a Group IVA metal, a Group IVB metal, a Group IB metal, or a Group IIB metal; and p+q+r=n wherein n is the valence of metal M.

6. The method of claim 5, wherein R¹ is a C₁-C₃₀ hydrocarbyl moiety and each of R², R³ and R⁴ independently hydrogen or a C₁-C₃₀ hydrocarbyl moiety.

7. The method of claim 5, wherein R¹ is a C₁-C₃₀ hydrocarbyl moiety substituted with a functional group containing halogen, oxygen, sulfur, nitrogen, silicon, or phosphorus, and wherein each of R², R³ and R⁴ is independently hydrogen or a C₁-C₃₀ hydrocarbyl moiety substituted with a functional group containing halogen, oxygen, sulfur, nitrogen, silicon, or phosphorus.
